(19) United States
(12) Patent Application Publication
(10) Pub. No.: US 2026/0268568 A1
(43) Pub. Date: Sep. 10, 2026

(54) PROGRAM, INFORMATION PROCESSING APPARATUS, AND INFORMATION PROCESSING METHOD

(71) Applicant: SONY GROUP CORPORATION, TOKYO (JP)

(72) Inventors: YOTARO SHIMOSE, TOKYO (JP); HIKARU TAKATORI, TOKYO (JP)

(21) Appl. No.: 19/166,817

(22) PCT Filed: Feb. 14, 2024
(86) PCT No.: PCT/JP2024/005007

§ 371 Date: Sep. 18, 2025

(30) Foreign Application Priority Data
Apr. 6, 2023 (JP) 2023-061946

(51) Int. Cl. G06T 13/40; G06T 7/20; G06T 7/70; G06V 40/16

(52) U.S. Cl. CPC G06T 13/40; G06T 7/20; G06T 7/70; G06V 40/174

(57) ABSTRACT

To make selection of motion suitable for text data efficient. A program causes a computer to function as: an acquisition unit that acquires a first feature amount calculated from first text data indicating an input first phrase; and a motion selection unit that selects, on the basis of a similarity between the first feature amount and a second feature amount that is a feature amount calculated from second text data indicating a second phrase associated with motion, at least one kind of motion from motion associated with each of a plurality of the second feature amounts as motion corresponding to the first feature amount.

### TECHNICAL FIELD

The present disclosure relates to a program, an information processing apparatus, and an information processing method.

### BACKGROUND ART

In recent years, a technology for selecting motion suitable for input text data has been developed. For example, Patent Document 1 discloses a technology for selecting motion of a sign language suitable for text data by translating the input text data into a sign language label.

Furthermore, Patent Document 2 discloses a technology for selecting motion suitable for an utterance sentence as text data according to a predefined rule.

### CITATION LIST

### Patent Document

Patent Document 1: Japanese Patent Application Laid-Open No. 2021-196708
Patent Document 2: International Publication No. WO 2020/170441

### Non-Patent Document

Non-Patent Document 1: SIGGRAPH Asia, 2020, [online], [Searched on March 28, 2023], Internet, <URL: https://sa2020.siggraph. org/en/attend/technical-papers/session_slot/57/13>

### SUMMARY OF THE INVENTION

### Problems to be Solved by the Invention

However, in the technology disclosed in Patent Document 1, a sign language label is repeatedly replaced until motion data corresponding to each of a plurality of sign language labels that is a translation result of text data is present for all the sign language labels. It is therefore difficult to select motion suitable for text data at runtime. In addition, the technology disclosed in Patent Document 2 requires a huge number of rules to be set in advance.

Thus, the present disclosure proposes a new and improved technology capable of making selection of motion suitable for text data efficient.

### SOLUTIONS TO PROBLEMS

According to the present disclosure, there is provided a program for causing a computer to function as: an acquisition unit that acquires a first feature amount calculated from first text data indicating an input first phrase; and a motion selection unit that selects, on the basis of a similarity between the first feature amount and a second feature amount that is a feature amount calculated from second text data indicating a second phrase associated with motion, at least one kind of motion from motion associated with each of a plurality of the second feature amounts as motion corresponding to the first feature amount.

Furthermore, according to the present disclosure, there is provided an information processing apparatus including: an acquisition unit that acquires a first feature amount calculated from first text data indicating an input first phrase; and a motion selection unit that selects, on the basis of a similarity between the first feature amount and a second feature amount that is a feature amount calculated from second text data indicating a second phrase associated with motion, at least one kind of motion from motion associated with each of a plurality of the second feature amounts as motion corresponding to the first feature amount.

Furthermore, according to the present disclosure, there is provided an information processing method to be executed by a computer, the method including: acquiring a first feature amount calculated from first text data indicating an input first phrase; and selecting, on the basis of a similarity between the first feature amount and a second feature amount that is a feature amount calculated from second text data indicating a second phrase associated with motion, at least one kind of motion from motion associated with each of a plurality of the second feature amounts as motion corresponding to the first feature amount.

### BRIEF DESCRIPTION OF DRAWINGS

FIG. 1 is a view for describing outline of an information processing system 1 according to an embodiment of the present disclosure.

FIG. 2 is a block diagram illustrating a functional configuration example of a data generation device 10 according to the present embodiment.

FIG. 3 is a view for describing reference text data and reference motion extracted by a data set extraction unit 131.

FIG. 4 is a view for describing an example of a way of division by an utterance section.

FIG. 5 is a view for describing a reference feature amount extracted on the basis of reference text data Sr.

FIG. 6 is a block diagram illustrating a functional configuration example of a server 20 according to the present embodiment.

FIG. 7 is a view for describing an example of processing of selecting motion corresponding to partial utterance text data.

FIG. 8 is a view for describing an example of a method of selecting a reference feature amount Vr from a plurality of reference feature amounts Vr.

FIG. 9 is a view for describing an example of the method of selecting the reference feature amount Vr from the plurality of reference feature amounts Vr.

FIG. 10 is a view for describing an example of the method of selecting the reference feature amount Vr from the plurality of reference feature amounts Vr.

FIG. 11 is a view for describing an example of applying reference motion Mr selected by a motion selection unit 236 to an interactive character.

FIG. 12 is a flowchart indicating an example of flow of processing of generating the reference feature amount Vr and the reference motion Mr by the data generation device 10 according to the present embodiment.

FIG. 13 is a flowchart indicating an example of flow of motion output by the server 20 according to the present embodiment.

FIG. 14 is a view for explaining an example in which the reference motion Mr is acquired on the basis of UGC.

FIG. 15 is a view for describing an example in which the reference motion Mr is acquired from moving image data of a moving image including a text.

FIG. 16 is a view for describing an example in which an emotion label is further extracted by the data set extraction unit 131.

FIG. 17 is a view for describing an example in which the reference motion Mr is filtered by an emotion label E1.

FIG. 18 is a view for describing an example in which the motion selected by the motion selection unit 236 is applied to a stamp of a character.

FIG. 19 is a block diagram illustrating a hardware configuration example of an information processing apparatus 900 that implements the data generation device 10, a motion DB 11, the server 20, and a user terminal 30 according to an embodiment of the present disclosure.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configuration are denoted by the same reference signs, and redundant description is omitted.

In addition, in the present specification and drawings, a plurality of components having substantially the same functional configuration may be distinguished from each other with different numbers or alphabets attached after the same reference sign. However, in a case where each of the plurality of components having substantially the same functional configuration does not need to be particularly distinguished from each other, each of the plurality of components is denoted by only the same reference sign.

Note that the description will be given in the following order.
1. Outline of information processing system according to embodiment of the present disclosure
2. Functional configuration example according to present embodiment
2-1. Functional configuration example of data generation device 10
2-2. Functional configuration example of server 20
3. Operation processing example according to present embodiment
4. Modifications according to present embodiment
5. Hardware configuration
6. Supplementary notes

### 1. Outline of Information Processing System According to Embodiment of Present Disclosure

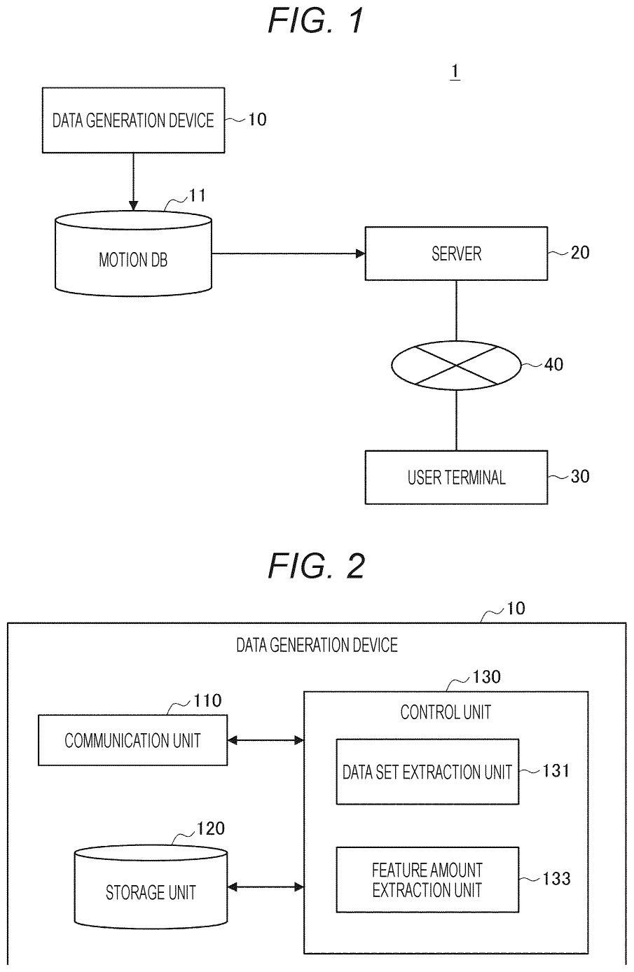

First, outline of an information processing system 1 according to a first embodiment of the present disclosure will be described with reference to FIG. 1. FIG. 1 is a view for describing outline of the information processing system 1 according to an embodiment of the present disclosure. As illustrated in FIG. 1, the information processing system 1 according to the present embodiment includes a data generation device 10, a motion DB 11, a server 20, a user terminal 30, and a network 40.

In the present embodiment, an example in which the server 20 selects motion to be applied to a display object to be output to the user terminal 30 according to a phrase to be uttered by the display object will be mainly described.

The display object may be, for example, a 2D or 3D character. More specifically, the display object may be an interactive character such as a non-player character (NPC) that communicates with a character operated by a user in a game or a metaverse service, a virtual avatar of the user, or the like.

In the present embodiment, an example of a case where the display object is an interactive character will be mainly described.

### (Review of Problems)

In related art, utterance text data representing an utterance phrase to be uttered by an interactive character and motion to be applied to the interactive character are manually set in advance and output. However, in order to enrich the utterance phrase and the motion, the above setting takes an enormous amount of time and effort.

Thus, in recent years, a technology for automatically generating utterance text data on the basis of machine learning according to a situation of a game, or the like, has been developed. However, it is difficult to set motion in advance for an utterance phrase generated on the basis of machine learning, and thus, the motion set in advance is output regardless of content of the utterance phrase.

Here, in a case where the motion set in advance does not match the content of the utterance phrase, the user who views the interactive character to which the motion is applied feels unnatural, and the user's sense of immersion is impaired. Thus, in order to enhance the user's sense of immersion, it is required to reflect motion suitable for the content of the utterance phrase at the runtime.

Thus, the server 20 according to the present embodiment generates a plurality of pieces of partial utterance text data indicating partial utterance phrases obtained by dividing an utterance phrase for each word or phrase. Then, the server 20 selects motion to be associated with each piece of partial utterance text data from reference motion stored in the data generation device 10.

Here, as a method of selecting motion, as disclosed in Patent Document 1, it is also conceivable to select motion to be associated with a partial utterance phrase by analyzing partial utterance text data according to a predefined rule. However, in order to output a huge variety of motion, it is necessary to define a large number of rules.

Furthermore, in a case where the partial utterance text data is analyzed by the rule, the meaning of the partial utterance phrase is not taken into account, and thus, there is a high possibility that motion that does not match the meaning of the partial utterance phrase may be selected.

In addition, Non-Patent Document 1 discloses a technology for acquiring a generation model that generates motion from speech and text data by machine learning. However, it has been pointed out that such a technology strongly depends on a size of the speech, and a technology for acquiring motion that matches the meaning of the partial utterance text data is required.

Thus, the present disclosure proposes a technology for making it possible to easily select motion that matches the meaning of partial utterance text data.

### (Server 20)

The server 20 according to the present embodiment is an example of an information processing apparatus that acquires a first feature amount calculated from first text data indicating an input first phrase. The first feature amount is a multi-dimensional vector calculated on the basis of a machine learning model.

Note that the phrase in the present specification is a word, or a phrase or sentence including a plurality of words.

In the present embodiment, an example in which the first phrase is the above-described partial utterance phrase and the first text data is the above-described partial utterance text data will be mainly described. Furthermore, the first feature amount in a case where the first text data is partial utterance text data is also referred to as a partial utterance feature amount.

Further, the server 20 selects motion corresponding to the first feature amount calculated from the first text data on the basis of a similarity between the first feature amount and a second feature amount.

Here, the second feature amount is a feature amount calculated from second text data indicating a second phrase associated with the motion. The second feature amount is a multi-dimensional vector calculated on the basis of the same machine learning model as the machine learning model of the first feature amount.

In the present embodiment, an example in which a set of the motion and the second text data indicating the second phrase is generated by the data generation device 10 will be mainly described. The second text data generated by the data generation device 10 is also referred to as reference text data. Further, the second phrase indicated by reference text data is also referred to as a reference phrase. Still further, the motion to be associated with the reference text data is also referred to as reference motion.

Furthermore, in the present embodiment, an example in which the second feature amount is a reference feature amount calculated on the basis of the reference text data will be mainly described.

The server 20 has a function of selecting at least one kind of motion from the motion associated with each of the plurality of second feature amounts as the motion corresponding to the first feature amount on the basis of the similarity between the acquired first feature amount and the second feature amount. In other words, in the example described in the present embodiment, the server 20 selects the motion to be associated with the partial utterance phrase from a plurality of kinds of reference motion on the basis of a similarity between the partial utterance feature amount and the reference feature amount.

Here, a higher similarity between the reference feature amount and the feature amount of the partial utterance text data indicates a high similarity between the reference text data corresponding to the reference feature amount and the meaning of the partial utterance text data. It is therefore possible to select the motion that matches the content of the partial utterance phrase by selecting the motion corresponding to the partial utterance phrase on the basis of the similarity. Details of the method of selecting the motion will be described below.

The server 20 transmits selected content data including a video of the interactive character reflecting the motion to be associated with the utterance text data to the user terminal 30 via the network 40.

### (Data Generation Device 10)

The data generation device 10 generates the reference text data to be referred to by the server 20 and the reference motion in association with each other as described above.

The reference motion indicates motion to be reflected on a display object. The reference motion to be associated with the reference text data is motion that can be performed when the display object utters the reference phrase indicated by the reference text data.

The data generation device 10 may acquire moving image data including a subject. Then, the data generation device 10 may acquire a set of the reference text data and the reference motion to be associated with the reference text data from the moving image data. The subject may be, for example, a person or a robot. Details of a method of acquiring the reference text data and the reference motion from the moving image data will be described later.

In addition, the data generation device 10 calculates a reference feature amount from the reference text data.

The data generation device 10 stores a set of the calculated reference feature amount and the reference motion corresponding to reference text data that is a calculation source of the reference feature amount in the motion DB 11.

### (Motion DB 11)

The motion DB 11 is a database that stores a plurality of sets of the reference feature amount and the reference motion, generated by the data generation device 10.

### (User Terminal 30)

The user terminal 30 is an information processing terminal to be used by the user. The user terminal 30 may be implemented by various devices such as a smartphone, a tablet terminal, a personal computer (PC), a game terminal, or a wearable device.

The user terminal 30 may be, for example, a terminal in which a game application including a video of an interactive character as provided content is installed.

Furthermore, the user terminal 30 may be a terminal to be used by the user to create a scenario of a game including utterance content and motion of the interactive character.

The user terminal 30 outputs the content data received from the server 20 to the user. For example, the user terminal 30 has a function of outputting a video of the interactive character included in the content data received from the server 20. Furthermore, the user terminal 30 may have a function of reproducing speech, or the like, to be uttered by the interactive character included in the content data received from the server 20.

### (Network 40)

The network 40 is a communication network that connects the server 20 and the user terminal 30 and enables data transmission and reception between the server 20 and the user terminal 30. The network 40 may be the Internet, a satellite communication network, a mobile communication network, a local area network (LAN), a wide area network (WAN), or the like.

The outline of the information processing system 1 according to an embodiment of the present disclosure has been described above. Note that the configuration described above with reference to FIG. 1 is merely an example, and the configuration of the information processing system 1 according to the present embodiment is not limited to such an example. For example, functions of the server 20 may be implemented by the user terminal 30.

### 2. Functional Configuration Example According to Present Embodiment

Subsequently, specific configuration of each device included in the information processing system 1 according to the present embodiment will be described with reference to the drawings.

### <2-1. Functional Configuration Example of Data Generation Device 10>

First, a functional configuration example of the data generation device 10 will be described with reference to FIG. 2. FIG. 2 is a block diagram illustrating the functional configuration example of the data generation device 10 according to the present embodiment.

As illustrated in FIG. 2, the data generation device 10 includes a communication unit 110, a storage unit 120, and a control unit 130.

### (Communication Unit 110)

The communication unit 110 performs various kinds of communication with the outside. The communication unit 110 transmits, for example, a set of a reference feature amount and reference motion generated by the control unit 130 to be described later to the motion DB 11.

Furthermore, the communication unit 110 acquires reference text data and moving image data as an extraction source of reference motion from the outside. The moving image data is data of a moving image including a subject. Furthermore, the moving image data may include speech data of speech to be uttered by the subject. The moving image data may be, for example, moving image data to be distributed by a moving image distribution service.

### (Storage Unit 120)

The storage unit 120 stores programs, operation parameters, and the like, to be used for processing of the control unit 130.

### (Control Unit 130)

The control unit 130 controls the entire operation of the data generation device 10. Furthermore, as illustrated in FIG. 2, the control unit 130 also functions as a data set extraction unit 131 and a feature amount extraction unit 133.

### (Data Set Extraction Unit 131)

The data set extraction unit 131 automatically extracts a set of reference text data and reference motion from the moving image data acquired by the communication unit 110 on the basis of machine learning.

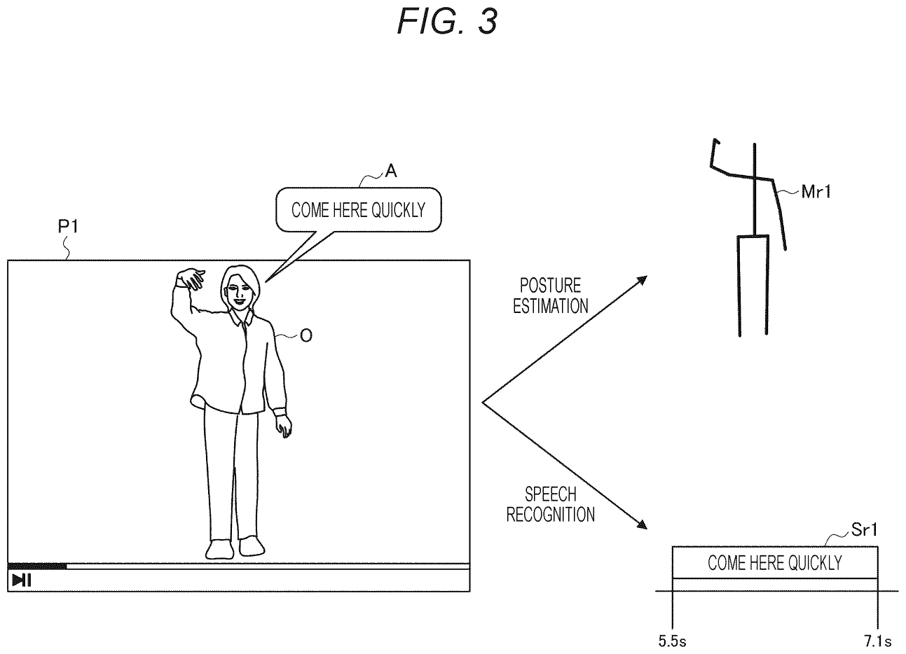

Here, the reference text data and the reference motion to be extracted by the data set extraction unit 131 will be described with reference to FIG. 3. FIG. 3 is a view for describing the reference text data and the reference motion to be extracted by the data set extraction unit 131.

FIG. 3 illustrates an example in which the data set extraction unit 131 extracts reference motion Mr1 and reference text data Sr1 from a moving image P1 including a subject O.

As described above, the moving image data of the moving image P1 includes speech data to be uttered by the subject O.

The data set extraction unit 131 executes speech recognition on the speech data included in the moving image data and converts the speech data into a text.

Then, the data set extraction unit 131 extracts utterance time for dividing the text by an utterance section. The data set extraction unit 131 generates the reference text data Sr by dividing the text by the utterance section according to the extracted utterance time.

For example, FIG. 3 illustrates an example in which the reference text data Sr1 is generated by converting the speech data including a speech A “Come here quickly” uttered by the subject O into a text.

Note that a way of division by the utterance section is not particularly limited. For example, the utterance section may be a section divided for each word, for each sentence, for each paragraph, or for each silent section.

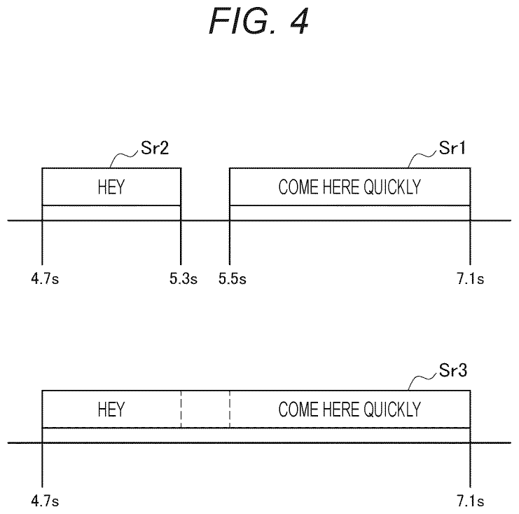

FIG. 4 is a view for describing an example of the way of division by the utterance section. In FIG. 4, examples of a way of dividing a speech of “Hey, come here quickly” is illustrated in an upper part and a lower part.

As illustrated in the upper part of FIG. 4, the utterance section may be divided for each silent section. In this case, reference text data Sr1 and reference text data Sr2 may be generated from the speech of “Hey, come here quickly”.

Furthermore, as illustrated in the lower part of FIG. 4, the utterance section may be divided for each sentence. In this case, reference text data Sr3 may be generated from the speech of “Hey, come here quickly”.

Description will be provided returning to FIG. 3. The data set extraction unit 131 extracts partial moving image data from the moving image data according to the utterance section described above. The data set extraction unit 131 acquires three-dimensional reference motion Mr1 by estimating a three-dimensional posture of the subject O in the partial moving image data.

Note that the data set extraction unit 131 may analyze expression of the face of the subject O in the partial moving image data and include motion of the expression in the reference motion Mr1.

FIG. 3 illustrates an example in which the reference motion Mr1 is acquired by estimating the posture of the subject O who is beckoning.

The data set extraction unit 131 associates the reference motion Mr1 acquired from the partial moving image data with the reference text data Sr1 acquired from the speech data included in the partial moving image data.

A method of extracting the reference motion Mr and the reference text data Sr by the data set extraction unit 131 has been described above with reference to FIG. 3. The data set extraction unit 131 automatically extracts the reference text data Sr and the reference motion Mr on the basis of machine learning.

According to the method of extracting the reference motion Mr and the reference text data Sr described above, it is not necessary to prepare a person such as an actor who performs motion in order to acquire the reference motion Mr and the reference text data Sr. Further, according to the above extraction method, a dedicated device for capturing the reference motion Mr is not required. Thus, according to such a configuration, it is possible to acquire the reference motion Mr and the reference text data Sr while reducing human cost and financial cost.

Furthermore, according to the above extraction method, a type of moving image data is not limited as long as the moving image data is moving image data including a subject performing utterance, and a set of the reference motion Mr and the reference text data Sr can be extracted from various kinds of moving image data. In other words, according to such a configuration, it is possible to enrich a set of the reference motion Mr and the reference text data Sr, which diversifies types of motion that can be output by the server 20.

Furthermore, by outputting the reference text data Sr and the reference motion Mr generated as described above to an external device including a display unit, it is possible to confirm in advance how the reference text data Sr is associated with the reference motion Mr. In other words, according to such a configuration, quality of motion can be confirmed in advance before the motion is applied to the interactive character by the server 20.

### Feature Amount Extraction Unit 133

The feature amount extraction unit 133 calculates a reference feature amount of the reference text data Sr acquired by the data set extraction unit 131 on the basis of a machine learning model.

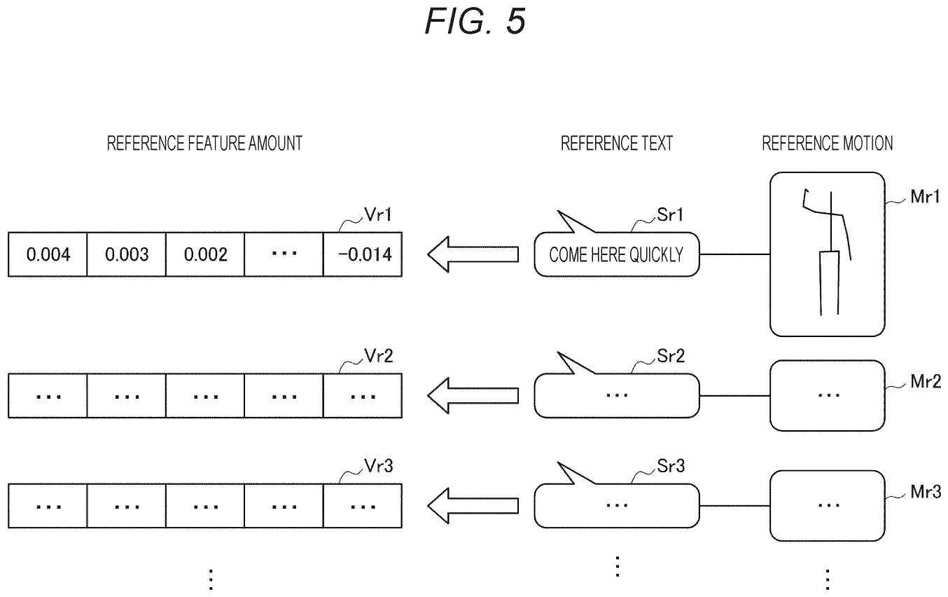

FIG. 5 is a view for describing the reference feature amount to be extracted on the basis of the reference text data Sr. As illustrated in FIG. 5, the feature amount extraction unit 133 calculates a reference feature amount Vr for each of the plurality of pieces of reference text data Sr acquired by the data set extraction unit 131.

The feature amount extraction unit 133 controls the communication unit 110 to store a set of the extracted reference feature amount Vr and the reference motion Mr to be associated with the reference text data Sr that is an extraction source of the reference feature amount Vr in the motion DB 11.

Note that the motion DB 11 may store a set of the reference feature amount Vr and the reference motion Mr with which the reference text data Sr is further associated.

### <2-2. Functional Configuration Example of Server 20>

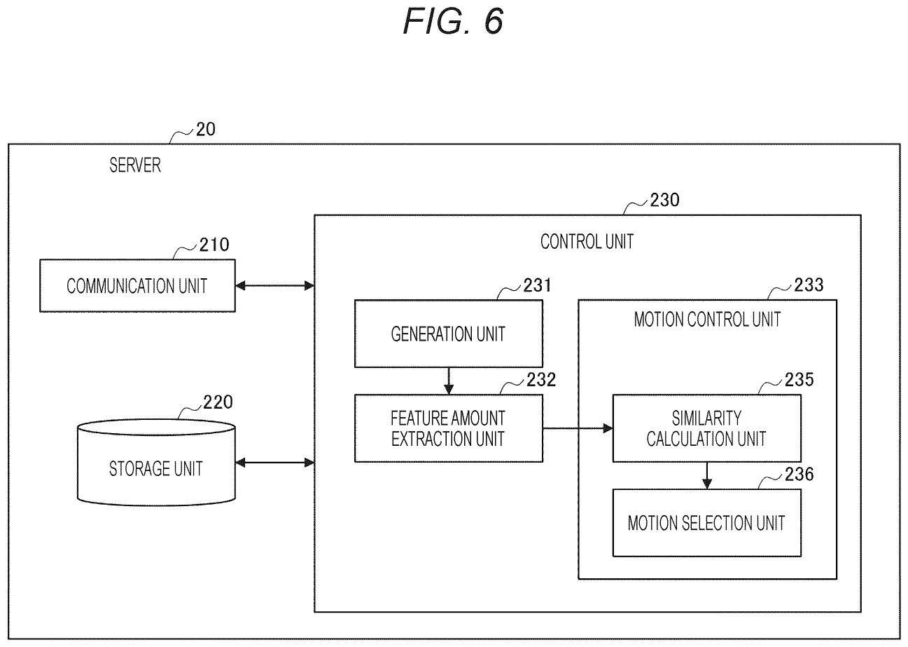

The functional configuration example of the data generation device 10 according to the present embodiment has been described above. Subsequently, a functional configuration example of the server 20 according to the present embodiment will be described with reference to FIG. 6. FIG. 6 is a block diagram illustrating the functional configuration example of the server 20 according to the present embodiment. As illustrated in FIG. 6, the server 20 includes a communication unit 210, a storage unit 220, and a control unit 230.

### (Communication Unit 210)

The communication unit 210 performs various kinds of communication with the outside. For example, the communication unit 210 may acquire a set of the reference feature amount Vr and the reference motion Mr from the motion DB 11.

Furthermore, the communication unit 210 transmits content data to the user terminal 30.

### (Storage Unit 220)

The storage unit 220 stores programs, operation parameters, and the like, to be used for processing of the control unit 230.

### (Control Unit 230)

The control unit 230 controls the entire operation of the server 20. Furthermore, as illustrated in FIG. 6, the control unit 230 also functions as a generation unit 231, a feature amount extraction unit 232, and a motion control unit 233.

### (Generation Unit 231)

The generation unit 231 generates a first phrase. As a more specific example, the generation unit 231 may generate a partial utterance phrase that is an example of the first phrase as described above. The partial utterance phrase is indicated by partial utterance text data that is the first text data.

More specifically, the generation unit 231 may first generate utterance text data indicating an utterance phrase according to a situation of a game, or the like. For example, the generation unit 231 may automatically generate utterance text data representing an utterance phrase to be uttered by the interactive character interacting with a character operated by the user using the user terminal 30 according to action of the character on the basis of machine learning according to a situation of the interaction.

Then, the generation unit 231 may generate partial utterance text data indicating a plurality of partial utterance phrases by dividing the generated utterance text data.

Here, the partial utterance text data is preferably generated by dividing the utterance phrase such that the partial utterance phrases indicated by the partial utterance text data have the same granularity as that of the reference phrase. For example, in a case where the reference text data Sr is generated such that the reference phrase is in units of words, it is preferable that the partial utterance text data is generated such that the partial utterance phrases are in units of words.

### (Feature Amount Extraction Unit 232)

The feature amount extraction unit 232 calculates a first feature amount from the first text data indicating the first phrase on the basis of a machine learning model. For example, the feature amount extraction unit 232 may calculate a partial utterance feature amount, which is an example of the first feature amount, from the partial utterance text data input from the generation unit 231.

Note that the first text data does not have to be generated by the feature amount extraction unit 232. For example, the partial utterance text data received by the communication unit 210 may be input to the feature amount extraction unit 232.

More specifically, the partial utterance text data received by the communication unit 210 may be an utterance phrase of the interactive character created by the user in a case where the user creates a scenario of a game including utterance content of the interactive character. In this case, the partial utterance text data to be input by the user to the user terminal 30 may be acquired by the communication unit 210.

Furthermore, the first text data to be input to the feature amount extraction unit 232 may be text data other than the partial utterance text data. For example, the first text data may be text data indicating a retrieval phrase to be used to retrieve motion to be applied to the display object by the user.

### (Motion Control Unit 233)

The motion control unit 233 acquires the first feature amount and selects motion corresponding to the first feature amount, thereby selecting motion corresponding to the first text data that is an extraction source of the first feature amount. In other words, in the example according to the present embodiment, the motion control unit 233 acquires a partial utterance feature amount and selects motion corresponding to partial utterance text data that is an extraction source of the partial utterance feature amount. As illustrated in FIG. 6, the motion control unit 233 also functions as a similarity calculation unit 235 and a motion selection unit 236.

### (Similarity Calculation Unit 235)

The similarity calculation unit 235 is an example of an acquisition unit that acquires the first feature amount. The similarity calculation unit 235 calculates a similarity between the first feature amount and the second feature amount. The similarity between the feature amounts may be represented by, for example, a Euclidean distance or a cosine similarity. In the present embodiment, an example in which the similarity calculation unit 235 calculates the similarity between the acquired partial utterance feature amount and each reference feature amount Vr acquired by the communication unit 210 will be described.

Note that the similarity may be calculated by the motion DB 11.

### (Motion Selection Unit 236)

The motion selection unit 236 selects motion corresponding to the first text data from motion associated with a plurality of second feature amounts on the basis of the similarity between the first feature amount and the second feature amount. More specifically, the motion selection unit 236 selects motion corresponding to the first feature amount from motion associated with the plurality of second feature amounts, thereby selecting motion corresponding to the first text data that is a calculation source of the first feature amount.

For example, on the basis of the similarity between the partial utterance feature amount calculated by the similarity calculation unit 235 and each reference feature amount Vr, the motion selection unit 236 selects at least one kind of reference motion Mr from a plurality of kinds of reference motion Mr as motion corresponding to the partial utterance feature amount.

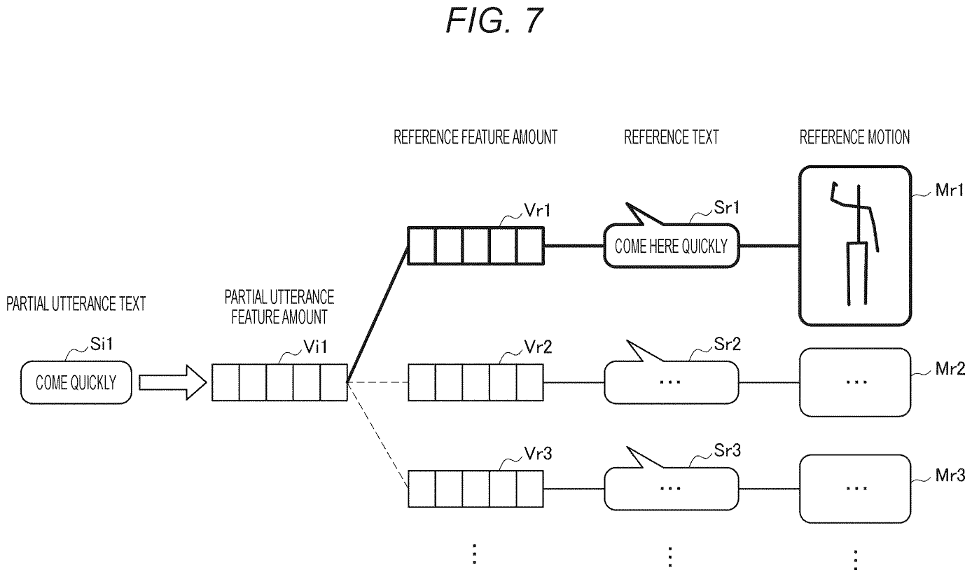

FIG. 7 is a view for describing an example of processing of selecting motion corresponding to partial utterance text data.

As described above, the feature amount extraction unit 232 extracts a partial utterance feature amount Vi1 from partial utterance text data Si1. Then, the similarity calculation unit 235 calculates a similarity between the partial utterance feature amount Vi1 and each of a plurality of reference feature amounts Vr.

Then, the motion selection unit 236 selects at least one reference feature amount Vr from the plurality of reference feature amounts Vr, thereby selecting reference motion Mr associated with the reference feature amount Vr as the motion corresponding to the partial utterance feature amount Vi.

For example, in the example illustrated in FIG. 7, the motion selection unit 236 selects the reference feature amount Vr1 from the plurality of reference feature amounts Vr, thereby selecting the reference motion Mr1 as the motion corresponding to the partial utterance feature amount Vi.

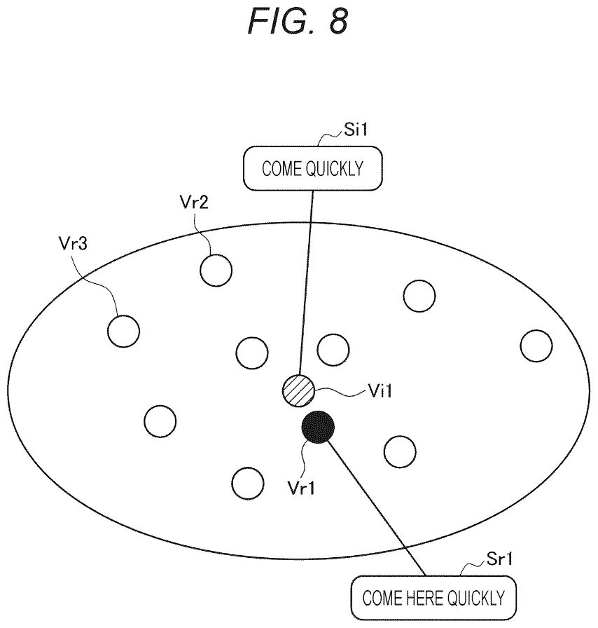

Here, an example of a method of selecting the reference feature amount Vr from the plurality of reference feature amounts Vr by the motion selection unit 236 will be described with reference to FIGS. 8 to 10. FIGS. 8 to 10 are views for describing an example of the method of selecting the reference feature amount Vr from the plurality of reference feature amounts Vr.

FIGS. 8 to 10 schematically illustrate a partial utterance feature amount Vi and a plurality of reference feature amounts Vr existing in a vector space. Here, a shorter distance between the feature amounts in the vector space represents a higher similarity between the feature amounts, that is, a higher similarity in meaning of phrases corresponding to the feature amounts.

As an example of the selection method, as illustrated in FIG. 8, the motion selection unit 236 may select a reference feature amount Vr having the highest similarity to the partial utterance feature amount Vi from the plurality of reference feature amounts Vr. In other words, the motion selection unit 236 may select the reference feature amount Vr having the shortest distance to the partial utterance feature amount Vi in the vector space from the plurality of reference feature amounts Vr.

FIG. 8 illustrates an example in which the reference feature amount Vr1 of the reference text data Sr1 indicating the reference phrase “Come quickly” having the shortest distance from the partial utterance feature amount Vi1 of the partial utterance text data Si1 indicating the partial utterance phrase “Come quickly” is selected.

The motion selection unit 236 can select the motion most suitable for the meaning of the partial utterance phrase by selecting the reference feature amount Vr having the highest similarity to the partial utterance feature amount Vi from the plurality of reference feature amounts Vr.

Furthermore, according to the above selection method, the same motion is always selected for the same partial utterance text data Si. In other words, by applying such a selection method, the motion to be applied to the interactive character can be made typical behavior, so that it is particularly effective as a method of selecting motion for the interactive character that is desired to give hard image such as a knight.

Furthermore, as another example of the selection method, the motion selection unit 236 may select a predetermined number of reference feature amounts Vr from the plurality of reference feature amounts Vr in descending order of similarity to the partial utterance feature amount Vi.

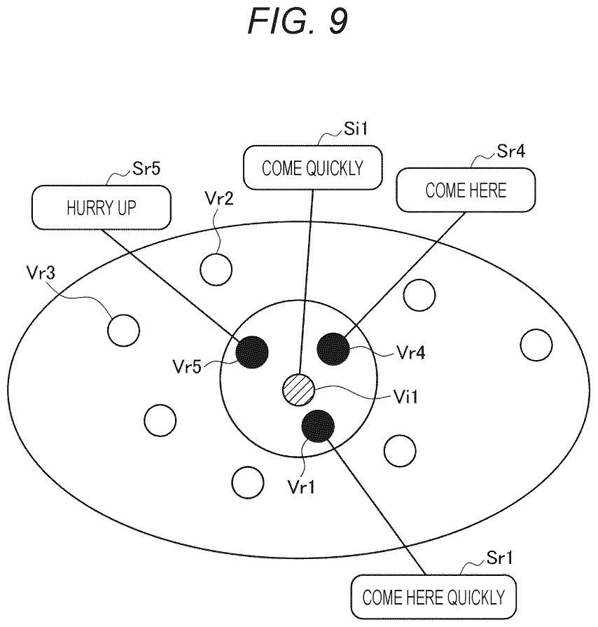

FIG. 9 illustrates an example in which three reference feature amounts Vr are selected from the plurality of reference feature amounts Vr in descending order of similarity to the partial utterance feature amount Vi. In the example illustrated in FIG. 9, reference feature amounts Vr1, Vr4, and Vr5 of reference text data Sr1, Sr4, and Sr5 may be selected in descending order of similarity to the partial utterance feature amount Vi1 of the partial utterance text data Si1 indicating the partial utterance phrase of “Come quickly”.

The above selection method may be used, for example, in a case where the user creates a scenario of a game. More specifically, the partial utterance text data Si may be created by the user, and in this case, a plurality of kinds of reference motion Mr respectively corresponding to the plurality of selected reference feature amounts Vr may be output to the user terminal 30 as candidates for motion to be applied to the interactive character. As a result, the user can finally determine motion corresponding to the partial utterance text data Si from the plurality of kinds of reference motion Mr suitable for the meaning of the partial utterance phrase.

Furthermore, as another example of the selection method, the motion selection unit 236 may randomly select one reference feature amount Vr from a predetermined number of reference feature amounts Vr selected in descending order of similarity to the partial utterance feature amount Vi from the plurality of reference feature amounts Vr.

In the example illustrated in FIG. 9, the motion selection unit 236 may randomly determine one reference feature amount Vr from three reference feature amounts Vr1, Vr4, and Vr5 selected in descending order of similarity to partial utterance feature amount Vi1.

According to the above configuration, types of motion to be selected for the same partial utterance text data Si increase.

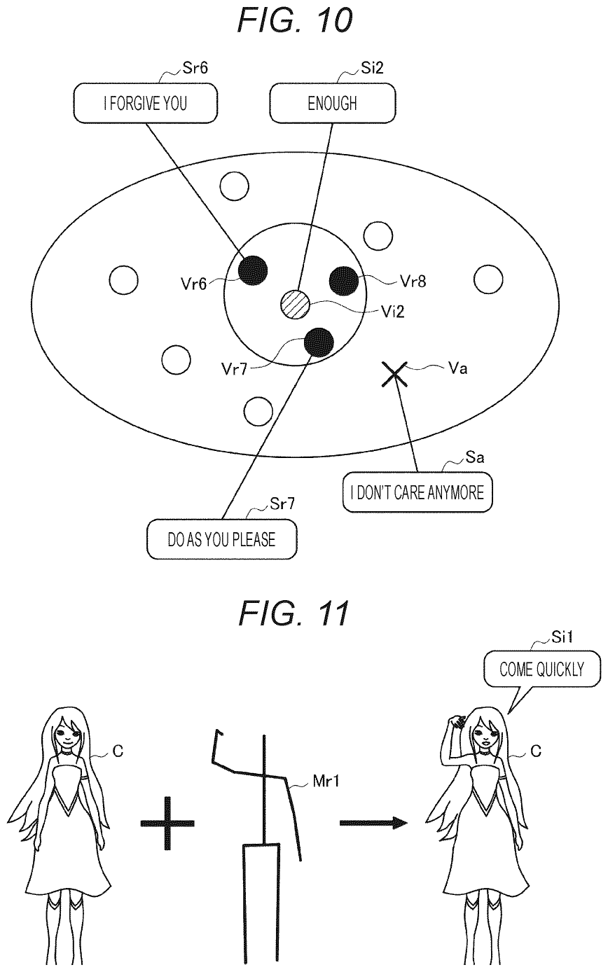

Subsequently, another example of the selection method will be described with reference to FIG. 10. A partial utterance phrase may include a plurality of meanings. Furthermore, it is also assumed that motion suitable for a partial utterance phrase varies depending on the meaning. It is therefore required to select motion more suitable for the meaning of the partial utterance phrase in the utterance situation.

Thus, the motion selection unit 236 may select the reference feature amount Vr further on the basis of the feature amount different from the partial utterance feature amount Vi and the reference feature amount Vr.

The feature amount different from the partial utterance feature amount Vi and the reference feature amount Vr may be a feature amount calculated from text data indicating a phrase input by the user to the user terminal 30. Such a phrase is also referred to as an additional phrase. Furthermore, such text data is also referred to as additional text data. Here, the additional phrase is an example of a third phrase, and the additional text data is an example of third text data.

The additional phrase may be, for example, a phrase having a meaning similar to that of the partial utterance phrase in the utterance situation. Furthermore, the additional phrase may be a phrase having a meaning similar to a meaning (that is, the meaning that is desired to be excluded from the selection result) different from the meaning in the utterance situation among the meanings included in the partial utterance phrase.

The feature amount extraction unit 232 calculates a feature amount of the additional text data. Then, the motion selection unit 236 selects motion on the basis of the similarity between the feature amount of the additional text data and the plurality of reference feature amounts Vr, calculated by the similarity calculation unit 235. Note that the feature amount of the additional text data is also referred to as an additional feature amount. The additional feature amount is an example of a third feature amount.

For example, it is assumed that the additional phrase is a phrase having a meaning similar to the meaning of the partial utterance phrase in the utterance situation. In this case, the motion selection unit 236 may select the reference feature amount Vr having the highest similarity to the additional feature amount from a predetermined number of reference feature amounts Vr selected in descending order of similarity to the partial utterance feature amount Vi1.

Furthermore, it is assumed that the additional phrase is a phrase having a meaning different from the meaning of the partial utterance phrase in the utterance situation. In this case, the motion selection unit 236 may select the reference feature amount Vr having the lowest similarity to the additional feature amount from a predetermined number of reference feature amounts Vr selected in descending order of similarity to the partial utterance feature amount Vi1.

For example, a partial utterance phrase “Enough” indicated by partial utterance text data Si2 illustrated in FIG. 10 can be interpreted to have a similar meaning to both an affirmative meaning of “I forgive you” and a negative meaning of “Do as you please”. Thus, in the example illustrated in FIG. 10, the motion selection unit 236 selects the reference feature amount Vr on the basis of the additional feature amount Va of the additional text data Sa indicating “I don't care anymore” which is an additional phrase having a negative meaning.

For example, it is assumed that the additional phrase is a phrase having a meaning different from the meaning of the partial utterance phrase in the utterance situation. In this case, the motion selection unit 236 may select the reference feature amount Vr6 having the lowest similarity to the additional feature amount Va from three reference feature amounts Vr6 to Vr8 selected in descending order of similarity to the partial utterance feature amount Vi1.

Note that, although an example in which the reference feature amount Vr is selected on the basis of one additional phrase has been described here, the reference feature amount Vr may be selected on the basis of a plurality of additional phrases.

The method of selecting the reference motion Mr corresponding to the partial utterance text data Si by the motion selection unit 236 has been described above. The motion selection unit 236 may apply the selected reference motion Mr to the interactive character and cause the communication unit 210 to output the applied reference motion Mr to the user terminal 30.

FIG. 11 is a view for describing an example of applying the reference motion Mr selected by the motion selection unit 236 to the interactive character. FIG. 11 illustrates an example in which the reference motion Mr1 has been selected as the motion corresponding to the partial utterance text data Si1 indicating the partial utterance phrase of “Come quickly”.

As illustrated in FIG. 11, the motion selection unit 236 applies the reference motion Mr1 to the interactive character C. In this event, the motion selection unit 236 may cause the interactive character C to utter the partial utterance phrase indicated by the partial utterance text data Si1.

The motion selection unit 236 may control the communication unit 210 to output a video of the interactive character C that utters speech of the partial utterance phrase to the user terminal 30 at the same time as reproducing the reference motion Mr1. Furthermore, the motion selection unit 236 may control the communication unit 210 to output a video including a text indicating the partial utterance phrase and the interactive character reproducing the reference motion Mr1 to the user terminal 30.

### 3. Operation Processing Example According to Present Embodiment

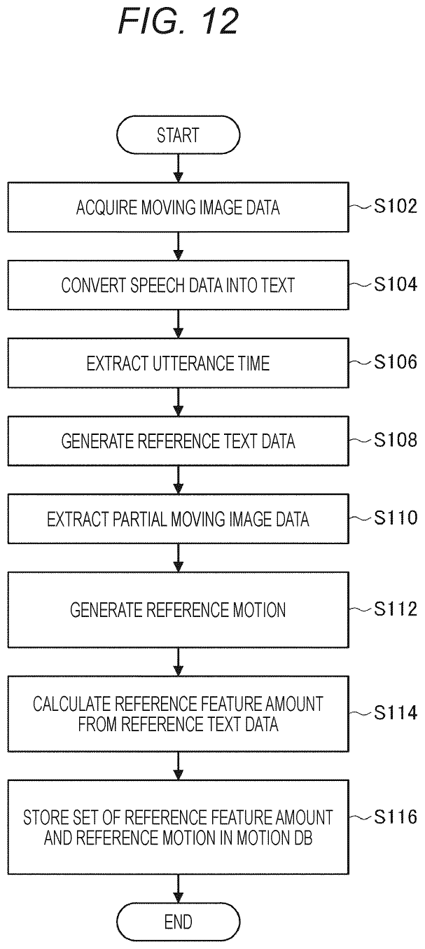

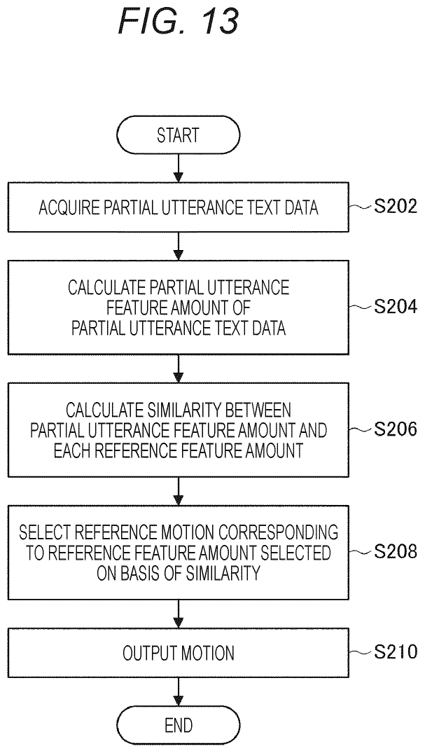

Subsequently, an operation processing example according to the present embodiment will be described using FIG. 12 and FIG. 13. FIG. 12 is a flowchart indicating an example of flow of processing of generating the reference feature amount Vr and the reference motion Mr by the data generation device 10 according to the present embodiment.

First, the communication unit 110 acquires moving image data that is an extraction source of the reference feature amount Vr and the reference motion Mr (S102).

The data set extraction unit 131 converts speech data included in the moving image data into a text (S104). Then, the data set extraction unit 131 extracts utterance time for dividing the text by the utterance section (S106). The data set extraction unit 131 generates reference text data Sr by dividing the text by the utterance section according to the utterance time (S108).

The data set extraction unit 131 extracts partial moving image data according to the utterance time (S110). Then, the data set extraction unit 131 generates the reference motion Mr by estimating a posture of the subject in the partial moving image data (S112).

Then, the feature amount extraction unit 133 calculates the reference feature amount Vr from the extracted reference text data Sr (S114).

The communication unit 110 stores a set of the acquired reference motion Mr and the reference feature amount Vr of the reference text data Sr associated with the reference motion Mr by transmitting the set to the motion DB 11 (S116).

Subsequently, an example of flow of motion output by the server 20 according to the present embodiment will be described with reference to FIG. 13. FIG. 13 is a flowchart indicating an example of the flow of the motion output by the server 20 according to the present embodiment.

First, the feature amount extraction unit 232 acquires partial utterance text data Si (S202). The partial utterance text data Si may be generated on the basis of the utterance text data generated by the generation unit 231, or may be acquired from the outside by the communication unit 210.

The feature amount extraction unit 232 generates a partial utterance feature amount Vi of the partial utterance text data Si (S204).

The similarity calculation unit 235 calculates a similarity between the partial utterance feature amount Vi extracted by the feature amount extraction unit 232 and each of the reference feature amounts Vr stored in the motion DB 11 (S206).

The motion selection unit 236 selects the reference motion Mr corresponding to the reference feature amount Vr selected on the basis of the similarity as the motion corresponding to the partial utterance text data Si (S208).

The motion selection unit 236 controls the communication unit 210 to output a video in which the selected reference motion Mr is reflected in the interactive character (S210).

### 4. Modifications According to Present Embodiment

### <4.1. Method of Acquiring Reference Text Data and Reference Motion>

The operation example of the information processing system according to the present embodiment has been described above. The technology according to the present disclosure is not limited to the embodiment described above. For example, although the example in which the reference text data Sr and the reference motion Mr are generated from the moving image data has been described above, the reference text data Sr and the reference motion Mr may be generated by other methods.

For example, the reference text data Sr and the reference motion Mr may be acquired by collecting motion of an utterer such as an actor by a motion capture system. This makes it possible to acquire a set of the reference feature amount Vr and the reference motion Mr with high quality although it takes cost.

Furthermore, the reference text data Sr and the reference motion Mr may be collected on the basis of data analyzed by an existing image recognition technology.

Furthermore, the reference text data Sr and the reference motion Mr may be acquired on the basis of user generated contents (UGC). In recent years, a technology in which a general consumer owns a motion capture device, a camera with a depth sensor, or the like, and acquires motion data by an individual has become widespread. It is conceivable that such motion data is released and made available on a platform as the UGC.

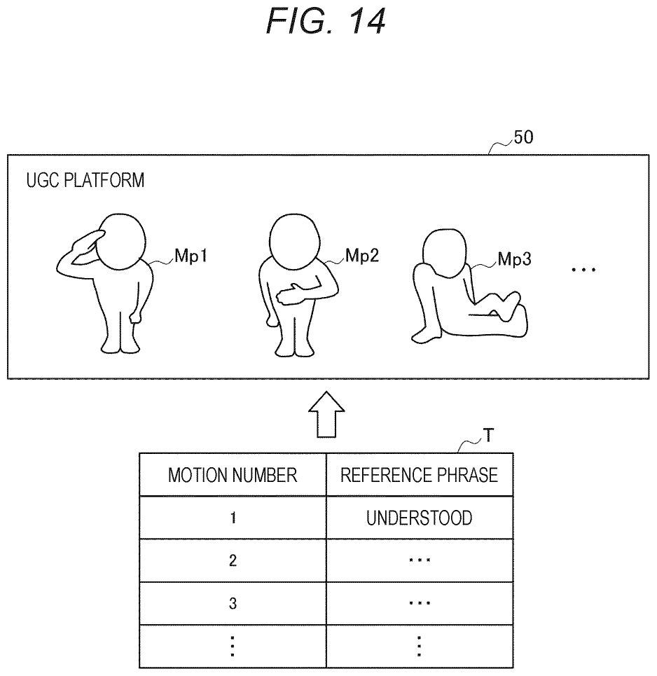

FIG. 14 is a view for describing an example in which the reference motion Mr is acquired on the basis of the UGC. In a modification which will described with reference to FIG. 14, the data generation device 10 is connected to a UGC platform 50. The UGC platform 50 stores a plurality of pieces of UGC motion Mp, which is motion posted by a user of the UGC platform 50.

In the present modification, the UGC motion Mp is used as the reference motion. Here, a pair of the UGC motion Mp and the reference text data Sr may be generated by providing the reference text data Sr to each piece of UGC motion Mp.

The reference text data Sr may be given by a table T indicated in FIG. 14. For example, the table T may be created by an administrator of the information processing system 1 according to the present embodiment and input to the data generation device 10.

The table T includes a motion number and a reference phrase. The motion number is a number for identifying the UGC motion Mp to be used as the reference motion. The reference phrase is a phrase indicated by the reference text data Sr given to the UGC motion identified by the motion number.

The example in which the reference text data Sr and the reference motion Mr are acquired on the basis of the UGC has been described above with reference to FIG. 14. As still another example of the method of acquiring the reference text data Sr and the reference motion Mr, the reference text data Sr and the reference motion Mr may be acquired from moving image data of a moving image including a text. The text included in the moving image may be, for example, a subtitle in which utterance content by the subject is transcribed.

Furthermore, the text included in the moving image may be a text input by a provider of the moving image as a phrase to be uttered by the subject in a pseudo manner. Here, the subject may be an animal.

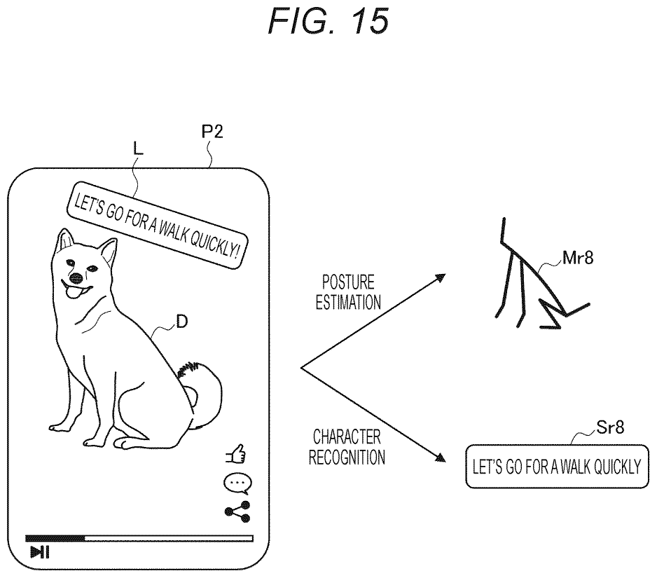

FIG. 15 is a view for describing an example in which the reference motion Mr is acquired from moving image data of a moving image including a text. The data set extraction unit 131 in the example described with reference to FIG. 15 acquires reference text data Sr8 by converting a text L included in a moving image P2 into text data by performing character recognition.

Furthermore, the data set extraction unit 131 acquires reference motion Mr8 by estimating a posture of a dog D, which is the subject in the moving image in an utterance section, using a period during which the text L appears in the moving image as the utterance section.

As described with reference to FIG. 15, by acquiring a pair of the reference motion Mr and the reference text data Sr, the reference text data Sr can be acquired even in a case where an animal, or the like, that does not utter a word is the subject.

In a case where motion is to be applied to a quadruped walking character, it is useful to select the motion to be applied from the reference motion Mr acquired in this manner.

### <4.2. Acquisition of Label>

Furthermore, while an example has been described above in which motion is selected on the basis of the similarity between the first feature amount and the second feature amount, the motion may be further selected on the basis of other kinds of information.

For example, the motion selection unit 236 may select motion on the basis of a first label associated with the first text data received by the communication unit 210. More specifically, the communication unit 210 may acquire the first label associated with the first text data. Then, the motion selection unit 236 may select motion from the motion associated with each of the plurality of second feature amounts corresponding to the second text data associated with a second label matching the first label.

Here, an example in which the first text data is text data representing a retrieval phrase will be described. Furthermore, here, as an example of the second label, a reference label associated with the reference text data Sr will be described.

The data generation device 10 may extract the reference label from the moving image data that is an acquisition source of the reference motion Mr and may associate the reference label with the reference text data. The reference label may be, for example, an emotion label representing emotion associated with the reference phrase.

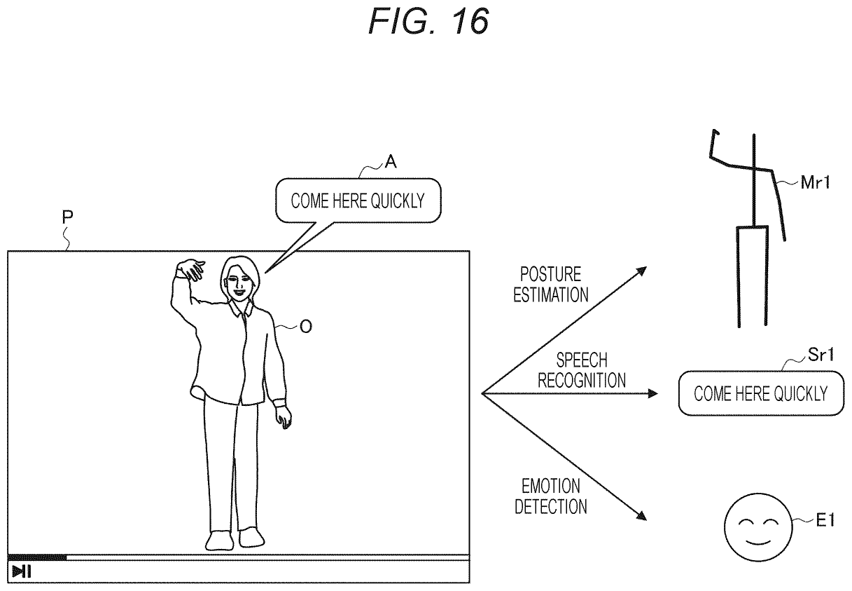

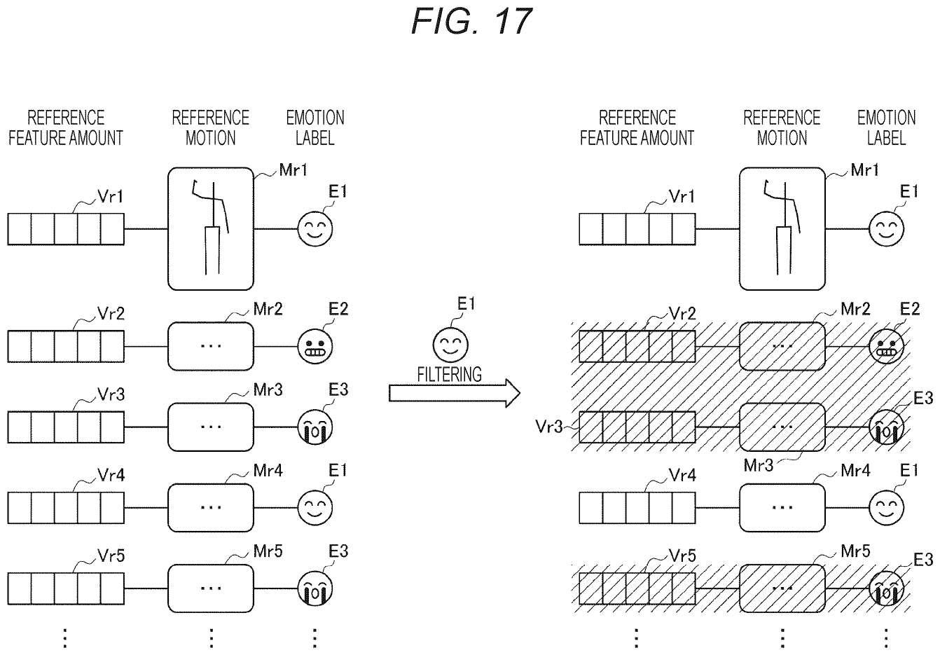

Here, an example in which the motion selection unit 236 selects motion using the reference label will be described with reference to FIGS. 16 and 17. FIG. 16 is a view for explaining an example in which an emotion label is further extracted by the data set extraction unit 131. FIG. 16 illustrates an example in which an emotion label E1 is further extracted in addition to the reference motion Mr1 and the reference text data Sr1 from the moving image P1 illustrated in FIG. 3.

The data set extraction unit 131 may detect emotion of the subject O from expression of the subject O in the partial moving image data extracted from the moving image data of the moving image P1 according to the utterance section, and generate the emotion label E1 to be associated with the reference text data Sr1. FIG. 16 illustrates an example in which the emotion label E1 is a label indicating emotion of joy.

The emotion label E may be automatically extracted on the basis of machine learning.

The emotion label E is included in a set of the reference feature amount Vr and the reference motion Mr and stored in the motion DB 11.

Here, the emotion label E may be used to filter the reference motion Mr upon retrieval of motion to be applied to the display object. In this case, the user designates the retrieval phrase and the emotion label E to be associated with the retrieval phrase to the user terminal 30 at the time of motion retrieval. The emotion label E designated by the user is an example of the first label.

FIG. 17 is a view for describing an example in which the reference motion Mr is filtered by the emotion label E1. The motion selection unit 236 performs filtering by selecting the reference feature amount Vr corresponding to the reference text data Sr associated with the emotion label E that matches the emotion label E designated by the user from a plurality of reference feature amounts Vr stored in the motion DB 11. Then, the motion selection unit 236 selects at least one kind of reference motion Mr from the reference motion Mr associated with the selected reference feature amount V.

FIG. 17 illustrates an example in which the motion selection unit 236 filters a set of the reference feature amount Vr, the reference motion Mr, and the emotion label E with the emotion label E1 indicating emotion of joy.

Even if the utterance content is the same, the motion requested by the user varies depending on the emotion assumed by the user as the emotion of the display object such as the interactive character. For example, it is assumed that there is the user's need to apply motion suitable for emotion of joy to the interactive character who has won in a game scenario.

Thus, by the user designating the emotion label E1 indicating the emotion of joy as a filtering condition, the motion selection unit 236 can select the reference motion Mr suitable for the emotion of joy from the reference motion Mr. This results in making it possible to prevent selection of sad reference motion Mr, angry reference motion Mr, or the like, as the motion of the interactive character who has won.

An example in which the reference label is a label representing emotion has been described above, but the reference label is not limited to this example. For example, the reference label may be a label representing an attribute of the subject such as physique or gender. The motion by the subject may differ depending on the attribute, and thus, it is possible to select motion more suitable for the interactive character by filtering with a label representing the attribute.

In addition, the reference label may be a label to be used for the purposes other than filtering. For example, the reference label may be a label indicating an attention direction of the subject. In this case, the reference label may be used when the motion is applied to the interactive character. More specifically, when the motion is applied to the interactive character, a positional relationship between the interactive character and an interaction partner (for example, a character operated by the user) can be adjusted according to the reference label.

### <4.3. Application Destination of Motion>

Furthermore, an example in which the motion selected by the motion selection unit 236 is to be applied to the interactive character has been described above, but the application destination of the motion is not limited thereto.

For example, the display object to which the motion is to be applied may be a character answering a question input by the user in a chatbot. In this case, the first text data may be text data indicating an answer sentence to the question.

Furthermore, the display object may be a stamp of a character that performs motion, to be used in a service for transmitting and receiving messages.

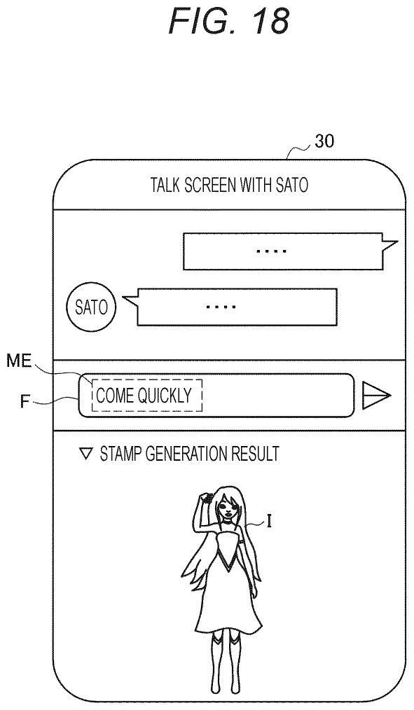

FIG. 18 is a view for describing an example in which the motion selected by the motion selection unit 236 is applied to the stamp of the character. The user inputs a message ME to be transmitted to a message input field F on a talk screen displayed on the display unit of the user terminal 30 and provided by the service for transmitting and receiving messages.

Here, the message ME is a first phrase in the example described with reference to FIG. 18. The feature amount extraction unit 232 extracts a feature amount of text data of the message ME. The motion selection unit 236 selects motion from the reference motion Mr on the basis of a similarity between the feature amount and the reference feature amount Vr, and performs control to output a stamp I obtained by applying the selected motion to the character to the user terminal 30.

The character to which the motion is to be applied may be, for example, a character for which right to use the stamp of the character has been purchased in advance by the user.

According to such a configuration, it is possible to provide stamps of the character that performs various kinds of motion in accordance with the content of the message, and thus, the service value is improved.

Further, the motion may be applied to an object other than the display object. For example, the motion may be applied to a real object such as a robot.

### 5. Hardware Configuration Example

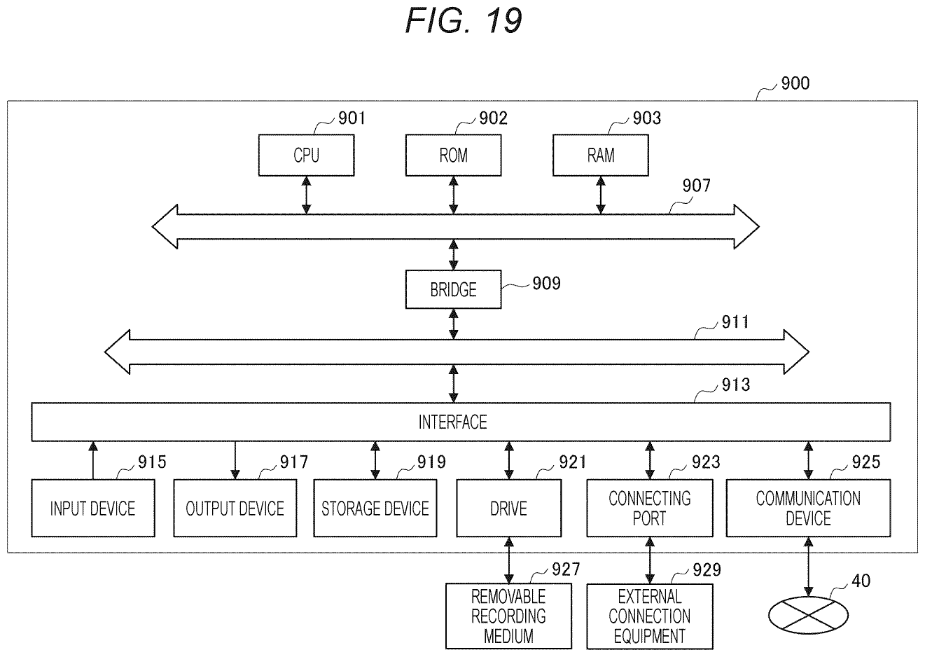

Next, a hardware configuration example of the information processing apparatus according to the embodiment of the present disclosure will be described with reference to FIG. 19. The processing by the data generation device 10, the motion DB 11, the server 20, and the user terminal 30 described above may be implemented by one or a plurality of information processing apparatuses. FIG. 19 is a block diagram illustrating a hardware configuration example of an information processing apparatus 900 for implementing the data generation device 10, the motion DB 11, the server 20, and the user terminal 30 according to the embodiment of the present disclosure.

Note that, the information processing apparatus 900 does not necessarily have the entire hardware configuration illustrated in FIG. 19. In addition, part of the hardware configuration illustrated in FIG. 19 does not have to exist in the data generation device 10, the motion DB 11, the server 20, or the user terminal 30.

As illustrated in FIG. 19, the information processing apparatus 900 includes a central processing unit (CPU) 901, a read only memory (ROM) 903, and a random access memory (RAM) 905. Furthermore, the information processing apparatus 900 may also include a host bus 907, a bridge 909, an external bus 911, an interface 913, an input device 915, an output device 917, a storage device 919, a drive 921, a connecting port 923, and a communication device 925. The information processing apparatus 900 may include a processing circuit called a graphics processing unit (GPU), a digital signal processor (DSP), or an application specific integrated circuit (ASIC) instead of or in addition to the CPU 901.

The CPU 901 functions as an arithmetic processing device and a control device, and controls overall operation in the information processing apparatus 900 or part thereof, in accordance with various programs recorded in the ROM 903, the RAM 905, the storage device 919, or a removable recording medium 927. The ROM 903 stores programs, operation parameters, and the like, to be used by the CPU 901. The RAM 905 temporarily stores a program to be used in execution by the CPU 901, parameters that change as appropriate during the execution, and the like.

The CPU 901, the ROM 903, and the RAM 905 are mutually connected by the host bus 907 including an internal bus such as a CPU bus. Moreover, the host bus 907 is connected to the external bus 911 such as a peripheral component interconnect/interface (PCI) bus via the bridge 909. For example, the control unit 130 and the control unit 230 according to the present embodiment may be implemented by the CPU 901.

The input device 915 is, for example, a device, such as a button, to be operated by the user. The input device 915 may include a mouse, a keyboard, a touch panel, a switch, a lever, and the like. Furthermore, the input device 915 may include a microphone that detects user's speech. The input device 915 may be, for example, a remote control device using infrared rays or other radio waves, or may be external connection equipment 929 such as a mobile phone adapted to operation of the information processing apparatus 900. The input device 915 includes an input control circuit that generates an input signal on the basis of information input by the user and outputs the input signal to the CPU 901. By operating the input device 915, the user inputs various types of data or gives an instruction to perform processing operation, to the information processing apparatus 900.

Furthermore, the input device 915 may include an imaging device and a sensor. The imaging device is, for example, a device that generates a captured image by imaging a real space using various members such as an imaging element including a charge coupled device (CCD) or a complementary metal oxide semiconductor (CMOS), a lens for controlling image formation of a subject image on the imaging element, and the like. The imaging device may capture a still image, or may capture a moving image.

Examples of the sensor include various types of sensors, such as a range sensor, an accelerometer, a gyro sensor, a geomagnetic sensor, a vibration sensor, an optical sensor, a sound sensor, and the like. The sensor obtains information regarding a state of the information processing apparatus 900 itself such as attitude of a casing of the information processing apparatus 900, and information regarding a surrounding environment of the information processing apparatus 900 such as brightness or noise around the information processing apparatus 900, for example. Furthermore, the sensor may include a global positioning system (GPS) sensor that receives a GPS signal to measure the latitude, longitude, and altitude of the device.

The output device 917 includes a device that can visually or audibly notify the user of acquired information. The output device 917 may be, for example, a display device such as a liquid crystal display (LCD) or an organic electro-luminescence (EL) display, an audio output device such as a speaker or a headphone, and the like. Furthermore, the output device 917 may include a plasma display panel (PDP), a projector, a hologram, a printer device, or the like. The output device 917 outputs a result obtained by processing performed by the information processing apparatus 900 as a text or a video such as an image, or outputs the result as sound such as speech or audio. Furthermore, the output device 917 may include a lighting device, or the like, that brightens the surroundings.

The storage device 919 is a data storage device configured as an example of a storage unit of the information processing apparatus 900. The storage device 919 includes, for example, a magnetic storage device such as a hard disk drive (HDD), a semiconductor storage device, an optical storage device, a magneto-optical storage device, and the like. This storage device 919 stores programs and various types of data to be executed by the CPU 901, various types of data acquired from the outside, and the like.

The drive 921 is a reader/writer for the removable recording medium 927 such as a magnetic disk, an optical disc, a magneto-optical disk, or a semiconductor memory and is built in or externally attached to the information processing apparatus 900. The drive 921 reads information recorded in the attached removable recording medium 927 and outputs the information to the RAM 905. Furthermore, the drive 921 writes a record to the attached removable recording medium 927.

The connecting port 923 is a port for connecting a device directly to the information processing apparatus 900. The connecting port 923 may be, for example, a universal serial bus (USB) port, an IEEE 1394 port, a small computer system interface (SCSI) port, and the like. Furthermore, the connecting port 923 may be an RS-232C port, an optical audio terminal, a high-definition multimedia interface (HDMI (registered trademark)) port, and the like. By connecting the external connection equipment 929 to the connecting port 923, various types of data may be exchanged between the information processing apparatus 900 and the external connection equipment 929.

The communication device 925 is, for example, a communication interface including a communication device for connecting to a network 931, or the like. The communication device 925 may be, for example, a communication card for a wired or wireless local area network (LAN), Bluetooth (registered trademark), Wi-Fi (registered trademark), or a wireless USB (WUSB). Furthermore, the communication device 925 may be a router for optical communication, a router for asymmetric digital subscriber line (ADSL), a modem for various types of communication, or the like. The communication device 925 transmits and receives a signal, or the like, with, for example, the Internet or other communication equipment by using a predetermined protocol such as TCP/IP. Furthermore, the network 931 connected to the communication device 925 is a network connected by wire or wirelessly and is, for example, the Internet, a home LAN, infrared communication, radio wave communication, satellite communication, or the like.

### 6. Supplementary Notes

While the preferred embodiment of the present disclosure has been described in detail with reference to the accompanying drawings, the technical scope of the present disclosure is not limited to such examples. It is obvious that those with ordinary skill in the technical field of the present disclosure can conceive various alterations or corrections within the scope of the technical idea recited in the claims, and it is naturally understood that those alterations or corrections also fall within the technical scope of the present disclosure.

For example, the data generation device 10, the motion DB 11, and the server 20 may be implemented as a server on a cloud.

Furthermore, the effects described in the present specification are merely exemplary or illustrative, and are not restrictive. In other words, the technology according to the present disclosure may exhibit other effects apparent to those skilled in the art from the description of the present specification, in addition to the effects described above or instead of the effects described above.

In addition, it is also possible to create one or more computer programs for causing hardware such as a CPU, a ROM, and a RAM built in the data generation device 10, the motion DB 11, the server 20, and the user terminal 30 described above to exhibit the functions of the data generation device 10, the motion DB 11, and the server 20. Furthermore, a computer-readable storage medium that stores the one or more computer programs is also provided.

Furthermore, the effects described in the present specification are merely exemplary or illustrative, and are not restrictive. In other words, the technology according to the present disclosure may exhibit other effects apparent to those skilled in the art from the description of the present specification, in addition to the effects described above or instead of the effects described above.

Note that the following configurations also fall within the technological scope of the present disclosure.
(1)

A program causing a computer to function as:
an acquisition unit that acquires a first feature amount calculated from first text data indicating an input first phrase; and
a motion selection unit that selects,
on the basis of a similarity between the first feature amount and a second feature amount that is a feature amount calculated from second text data indicating a second phrase associated with motion,
at least one kind of motion from motion associated with each of a plurality of the second feature amounts as motion corresponding to the first feature amount.
(2)

The program according to (1), in which
the motion selection unit selects motion associated with a second feature amount having a highest similarity to the first feature amount from the plurality of second feature amounts.
(3)

The program according to (1), in which
the motion selection unit selects motion associated with each of a predetermined number of second feature amounts selected in descending order of similarity to the first feature amount from the plurality of second feature amounts.
(4)
he program according to (1), in which
the motion selection unit selects motion associated with one second feature amount randomly determined from a predetermined number of second feature amounts selected from the plurality of second feature amounts in descending order of similarity to the first feature amount.
(5)

The program according to (1), in which
the acquisition unit further acquires a third feature amount calculated from third text data indicating an input third phrase, and
the motion selection unit selects the motion in accordance with a similarity between the second feature amount and the third feature amount.
(6)

The program according to (5), in which
the motion selection unit selects a predetermined number of second feature amounts from the plurality of second feature amounts in descending order of similarity to the first feature amount and selects motion associated with a second feature amount having a lowest similarity to the third feature amount from the predetermined number of second feature amounts.
(7)

The program according to any one of (1) to (6), in which
the motion and the second text data are automatically acquired from moving image data on the basis of machine learning.
(8)

The program according to (7), in which
the motion is acquired by estimating a posture of a subject in partial moving image data extracted from the moving image data according to an utterance section, and
the second text data indicating the second phrase to be associated with the motion is acquired by converting speech data included in the partial moving image data that is an acquisition source of the motion into a text.
(9)

The program according to (8), in which
the utterance section is a section divided for each word, for each sentence, for each paragraph, or for each silent section.
(10)

The program according to any one of (7) to (9), in which
the acquisition unit further acquires a first label to be associated with the first text data,
the second text data is further associated with a second label by machine learning, and
the motion selection unit selects at least one kind of motion from motion associated with each of a plurality of the second feature amounts corresponding to second text data associated with the second label matching the first label.
(11)

The program according to (10), in which
the second label is associated with the second text data on the basis of moving image data that is an acquisition source of the motion.
(12)

The program according to (10) or (11), in which
the first label represents emotion to be associated with the first phrase, and
the second label represents emotion to be associated with the second phrase.
(13)

The program according to (12), in which
the second label is generated on the basis of expression of a subject performing the motion in moving image data that is an acquisition source of the motion.
(14)

The program of any one of (1) to (13), in which
the first phrase is a phrase to be uttered by a display object.
(15)

The program of (14), in which
the display object is an interactive character, and
the first phrase is automatically generated in accordance with a situation of interaction.
(16)

The program according to any one of (1) to (15), in which
the motion includes motion of expression of a face.
(17)

The program according to any one of (1) to (16), in which
the first phrase is a phrase to be used to retrieve motion to be applied to a display object.
(18)

An information processing apparatus including:
an acquisition unit that acquires a first feature amount calculated from first text data indicating an input first phrase; and
a motion selection unit that selects,
on the basis of a similarity between the first feature amount and a second feature amount that is a feature amount calculated from second text data indicating a second phrase associated with motion,
at least one kind of motion from motion associated with each of a plurality of the second feature amounts as motion corresponding to the first feature amount.
(19)

An information processing method to be executed by a computer, the method including:
acquiring a first feature amount calculated from first text data indicating an input first phrase; and
selecting,
on the basis of a similarity between the first feature amount and a second feature amount that is a feature amount calculated from second text data indicating a second phrase associated with motion,
at least one kind of motion from motion associated with each of a plurality of the second feature amounts as motion corresponding to the first feature amount.

### REFERENCE SIGNS LIST

1 Information processing system
10 Reference data generation device
11 Motion DB
20 Server
30 User terminal
110 Communication unit
120 Storage unit
130 Control unit
131 Data set extraction unit
133 Feature amount extraction unit
210 Communication unit
220 Storage unit
230 Control unit
231 Generation unit
232 Feature amount extraction unit
233 Motion control unit
235 Similarity calculation unit
236 Motion selection unit

1. A program causing a computer to function as:
an acquisition unit that acquires a first feature amount calculated from first text data indicating an input first phrase; and
a motion selection unit that selects,
on a basis of a similarity between the first feature amount and a second feature amount that is a feature amount calculated from second text data indicating a second phrase associated with motion,
at least one kind of motion from motion associated with each of a plurality of the second feature amounts as motion corresponding to the first feature amount.

2. The program according to claim 1, wherein
the motion selection unit selects motion associated with a second feature amount having a highest similarity to the first feature amount from the plurality of second feature amounts.

3. The program according to claim 1, wherein
the motion selection unit selects motion associated with each of a predetermined number of second feature amounts selected in descending order of similarity to the first feature amount from the plurality of second feature amounts.

4. The program according to claim 1, wherein
the motion selection unit selects motion associated with one second feature amount randomly determined from a predetermined number of second feature amounts selected from the plurality of second feature amounts in descending order of similarity to the first feature amount.

5. The program according to claim 1, wherein
the acquisition unit further acquires a third feature amount calculated from third text data indicating an input third phrase, and
the motion selection unit selects the motion in accordance with a similarity between the second feature amount and the third feature amount.

6. The program according to claim 5, wherein
the motion selection unit selects a predetermined number of second feature amounts from the plurality of second feature amounts in descending order of similarity to the first feature amount and selects motion associated with a second feature amount having a lowest similarity to the third feature amount from the predetermined number of second feature amounts.

7. The program according to claim 1, wherein
the motion and the second text data are automatically acquired from moving image data on a basis of machine learning.

8. The program according to claim 7, wherein
the motion is acquired by estimating a posture of a subject in partial moving image data extracted from the moving image data according to an utterance section, and
the second text data indicating the second phrase to be associated with the motion is acquired by converting speech data included in the partial moving image data that is an acquisition source of the motion into a text.

9. The program according to claim 8, wherein
the utterance section is a section divided for each word, for each sentence, for each paragraph, or for each silent section.

10. The program according to claim 7, wherein
the acquisition unit further acquires a first label to be associated with the first text data,
the second text data is further associated with a second label by machine learning, and
the motion selection unit selects at least one kind of motion from motion associated with each of a plurality of the second feature amounts corresponding to second text data associated with the second label matching the first label.

11. The program according to claim 10, wherein
the second label is associated with the second text data on a basis of moving image data that is an acquisition source of the motion.

12. The program according to claim 10, wherein
the first label represents emotion to be associated with the first phrase, and
the second label represents emotion to be associated with the second phrase.

13. The program according to claim 12, wherein
the second label is generated on a basis of expression of a subject performing the motion in moving image data that is an acquisition source of the motion.

14. The program according to claim 1, wherein
the first phrase is a phrase to be uttered by a display object.

15. The program according to claim 14, wherein
the display object is an interactive character, and
the first phrase is automatically generated in accordance with a situation of interaction.

16. The program according to claim 1, wherein
the motion includes motion of expression of a face.

17. The program according to claim 1, wherein
the first phrase is a phrase to be used to retrieve motion to be applied to a display object.

18. An information processing apparatus comprising:
an acquisition unit that acquires a first feature amount calculated from first text data indicating an input first phrase; and
a motion selection unit that selects,
on a basis of a similarity between the first feature amount and a second feature amount that is a feature amount calculated from second text data indicating a second phrase associated with motion,
at least one kind of motion from motion associated with each of a plurality of the second feature amounts as motion corresponding to the first feature amount.

19. An information processing method to be executed by a computer, the method comprising:
acquiring a first feature amount calculated from first text data indicating an input first phrase; and
selecting,
on a basis of a similarity between the first feature amount and a second feature amount that is a feature amount calculated from second text data indicating a second phrase associated with motion,
at least one kind of motion from motion associated with each of a plurality of the second feature amounts as motion corresponding to the first feature amount.
